(19) United States
(12) Patent Application Publication
(10) Pub. No.: US 2014/0177243 A1
(43) Pub. Date: Jun. 26, 2014

(54) APPARATUS AND METHOD FOR CONTROLLING HEAD LAMP OF VEHICLE

(71) Applicant: HYUNDAI MOTOR COMPANY, Seoul (KR)

(72) Inventor: Dong Gyu Noh, Dongducheon (KR)

(73) Assignee: HYUNDAI MOTOR COMPANY, Seoul (KR)

(21) Appl. No.: 13/889,673

(22) Filed: May 8, 2013

(30) Foreign Application Priority Data
Dec. 20, 2012 (KR) 10-2012-0149446

(51) Int. Cl. F21S 8/10

(52) U.S. Cl. CPC F21S 48/17
USPC 362/466

(57) ABSTRACT

An apparatus and a method for controlling a head lamp of a vehicle. In particular, road information is analyzed which is collected in the vicinity of the vehicle through a sensor to identify a road state. Additionally, information relating a rear vehicle positioned behind the vehicle from the information collected in the vicinity of the vehicle or information obtained through communication between vehicles is analyzed to determine a driving situation of the rear vehicle. Based on this information, a head lamp setting unit sets a control length and a control width of the head lamp based on the road state and the driving situation of the rear vehicle. As a result, a head lamp driving unit drives the head lamp based on the set control length and control width of the head lamp.

### CROSS-REFERENCE TO RELATED APPLICATION

This application is based on and claims priority from Korean Patent Application No. 10-2012-0149446, filed on Dec. 20, 2012 in the Korean Intellectual Property Office, the disclosure of which is incorporated herein in its entirety by reference.

### BACKGROUND OF THE INVENTION

1. Field of the invention

The present invention relates to an apparatus and a method for controlling a head lamp of a vehicle, and more particularly, to a technology of controlling a lighting area of a head lamp based on a front vehicle, a rear vehicle, and road information.

2. Description of the Prior Art

Generally, when a driver's vision becomes impaired due to for example, nighttime travel, bad weather, etc., head lamps of a vehicle are typically activated to secure a proper visual field in front of the vehicle in order to the driver to operate the vehicle safely. However, since a lighting length, width, angle, and the like, of the head lamp are typically a fixed value (depending upon wither high or low beams are selected),the head lamps of oncoming vehicles and vehicles travelling along side of the vehicle often affect the driver's visual field and can sometimes have a blinding effect.

As a solution reducing the blinding effect on other drivers on the road, some systems have disposed sensors in the front of the vehicle to sense that other vehicles are either approaching or traveling in front the vehicle in which the sensor is installed. In response to sensing another vehicle by the sensors, of the head lamp may be adjusted based on the sensed position of the other vehicle to prevent the blinding effect of other vehicles in front of the vehicle in which the sensor is installed. However, currently the systems that are in place do not detect vehicles approaching from behind the vehicle.

### SUMMARY OF THE INVENTION

Accordingly, the present invention has been made to solve the above-mentioned problems occurring in the prior art while advantages achieved by the prior art are maintained intact.

In one aspect, the present invention provides an apparatus and a method for controlling a head lamp of a vehicle that prevents a field of vision of a driver of a rear vehicle (i.e., a vehicle behind the vehicle in which the system is installed) from becoming obstructed by light glare by controlling the head lamp of the vehicle in advance based on driving prediction path information of the rear vehicle. That is, the head lamps of the vehicle are controlled before the rear vehicles travels in front of the vehicle in which the system is installed.

Another subject to be achieved by the present invention is to provide an apparatus and a method for controlling a head lamp of a vehicle that secures field of vision of a driver of the vehicle and prevents a field of vision of a driver of a peripheral vehicle from being obscured by adjusting a lighting area of the head lamp of the vehicle according to the relative positions of a front vehicle and a rear vehicle and a road situation.

In one aspect of the present invention, there is provided an apparatus for controlling a head lamp of a vehicle, the apparatus including: a road information analyzing unit that analyzes information on a road on which a vehicle is being driven from information collected in the vicinity of the vehicle through a sensor to recognize a road state; a rear vehicle information analyzing unit that analyzes information on a rear vehicle positioned at the rear of the vehicle from the information collected in the vicinity of the vehicle or information obtained through communication between vehicles to identify a driving situation of the rear vehicle; a head lamp setting unit that sets a control length and a control width of the head lamp based on the road state and the driving situation of the rear vehicle; and a head lamp driving unit that operates the head lamp based on the set control length and control width of the head lamp.

In some exemplary embodiments of the present invention, the head lamp setting unit may set the control length and the control width of the head lamp according to a driving prediction path and a speed of the rear vehicle. The head lamp driving unit may control driving of the head lamp when the rear vehicle approaches a predetermined distance range of the rear of the vehicle.

The apparatus may further include, in some exemplary embodiments of the present invention, a front vehicle information analyzing unit that analyzes information on a front vehicle positioned in front of the vehicle from the information collected in the vicinity of the vehicle or information obtained through communication between vehicles to recognize a driving situation of the front vehicle.

The head lamp setting unit may set the control length and the control width of the head lamp by reflecting the driving situation of the front vehicle in the road state and the driving situation of the rear vehicle. This control length and the control width of the head lamp may be based on the road state and/or a final position coordinate value of a driving path history of the front vehicle when the rear vehicle is not present

The head lamp setting unit may also set the control length and the control width of the head lamp based on information on a road curvature when the rear vehicle and the front vehicle are not present.

Additionally, in certain exemplary embodiments, head lamp setting unit may set the control length and the control width of the head lamp based on a final position coordinate value of a driving path history of the front vehicle or a position of a stop line of the front when the vehicle is waiting for a signal at an intersection.

In another aspect of the present invention, there is provided a method for controlling a head lamp of a vehicle, the method including: analyzing, by a controller including a plurality of units, information on a road on which a vehicle is being driven from information collected in the vicinity of the vehicle via a sensor to identify a current state of a road; analyzing, by the controller, information on a rear vehicle positioned behind the vehicle based on the information collected in the vicinity of the vehicle or information obtained through communication between vehicles to identify a driving situation of the rear vehicle; setting, by the controller, a control length and a control width of the head lamp based on the road state and the driving situation of the rear vehicle; and operating the head lamp based on the set control length and control width of the head lamp.

In some exemplary embodiments, the control length and the control width of the head lamp may be set according to a driving prediction path and a speed of the rear vehicle. Additionally, the driving, driving of the head lamp may be controlled when the rear vehicle approaches a predetermined distance range of the rear of the vehicle.

The method may further include analyzing information related to a front vehicle positioned in front of the vehicle from the information collected in the vicinity of the vehicle or information obtained through communication between vehicles to recognize a driving situation of the front vehicle.

Furthermore, in some exemplary embodiments of the present invention, the control length and the control width of the head lamp may be set based on the road state and/or a final position coordinate value of a driving path history of the front vehicle when the rear vehicle is not present.

In addition, the control length and the control width of the head lamp may be set based on information on a road curvature when the rear vehicle and the front vehicle are not present, an/or on a final position coordinate value of a driving path history of the front vehicle or a position of a stop line of the front when the vehicle is in a state in which it waits for a signal at an intersection

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a configuration of an apparatus for controlling a head lamp of a vehicle according to an exemplary embodiment of the present invention;

FIGS. 2 to 6 are illustrative diagrams for describing an operation of the apparatus for controlling a head lamp of a vehicle according to the exemplary embodiment of the present invention; and

FIG. 7 is a flow chart showing an operation flow of a method for controlling a head lamp of a vehicle according to the exemplary embodiment of the present invention.

### DETAILED DESCRIPTION OF THE PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the tem “and/or” includes any and all combinations of one or more of the associated listed items.

Hereinafter, exemplary embodiments of the present invention will be described with reference to the accompanying drawings.

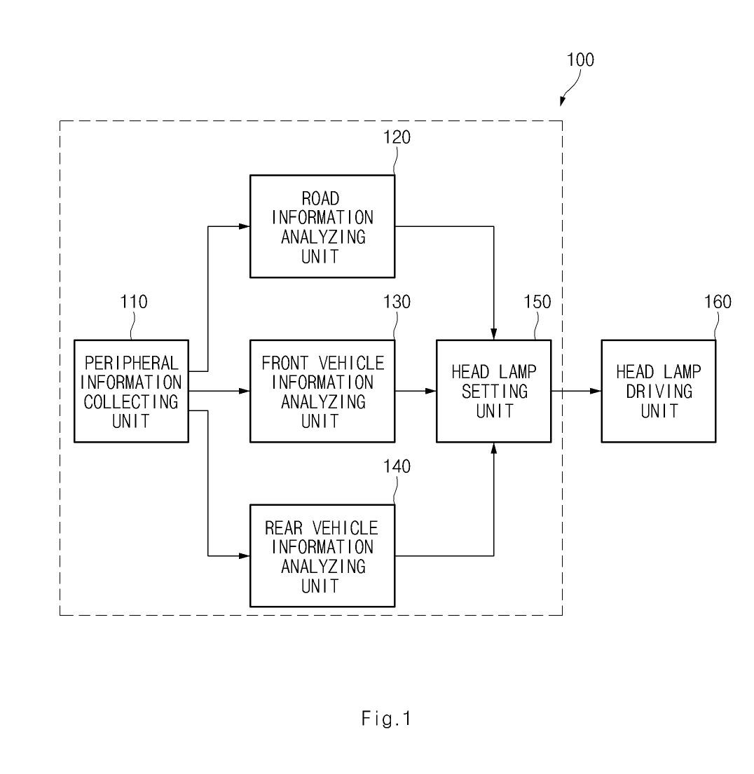

FIG. 1 is a block diagram showing a configuration of an apparatus for controlling a head lamp of a vehicle according to an exemplary embodiment of the present invention. Referring to FIG. 1, the apparatus for controlling a head lamp of a vehicle according to the exemplary embodiment of the present invention is configured to include a controller 100 that includes a peripheral information collecting unit 110, a road information analyzing unit 120, a front vehicle information analyzing unit 130, a rear vehicle information analyzing unit 140, a head lamp setting unit 150, and a head lamp driving unit 160.

First, the peripheral information collecting unit 110 is configured to collect peripheral information of a vehicle while the vehicle is being operated. Here, the peripheral information collecting unit 110 collects the peripheral information of the vehicle from a sensor value measured by a plurality of sensors provided within or on the vehicle.

As an example, the peripheral information collecting unit 110 collects information of other vehicles positioned in front or behind of the vehicle from distance measuring sensors disposed on the front and the rear of the vehicle. Here, the peripheral information collecting unit 110 collects information relating to vehicles in front or behind the vehicle in which the system is installed. These vehicles in front and/or behind may be positioned in a lane in which the vehicle is driven and/or in left and right lanes of the above-mentioned lane. In addition, the peripheral information collecting unit 110 may collect road information from in front of the vehicle, lane information, crossroad information, signal lamp information, vehicle position information, and the like, from an imaging device (e.g., a camera module), a global positioning system (GPS) module, or other sensors provided in the vehicle. Further, the peripheral information collecting unit 110 may perform vehicle to vehicle (V2V) communication with other vehicles using a communication module and collect information from other vehicles, for example, position information, path history information, and the like, of other vehicles, from the V2V communication. Further, the peripheral information collecting unit 110 may collect various information generated in the vicinity of the vehicle using a collecting unit provided in the vehicle.

The road information analyzing unit 120 analyzes road information in the peripheral information collected by the peripheral information collecting unit 110. In this case, the road information analyzing unit 120 analyzes the number of lanes of a road, a lane width, road curvature information, and the like.

The front vehicle information analyzing unit 130 analyzes information related to the front vehicle that is being driven in front of the vehicle from the peripheral information collected by the peripheral information collecting unit 110. Here, the front vehicle information analyzing unit 130 analyzes a position, a driving speed, a driving path history, and the like, of the front vehicle.

The rear vehicle information analyzing unit 140 analyzes information related to the rear vehicle that is being driven at the rear of the vehicle in the peripheral information collected by the peripheral information collecting unit 110. Here, the rear vehicle according to the exemplary embodiment of the present invention is a rear vehicle approaching a corresponding vehicle at a left or right lane of the corresponding vehicle. Here, the rear vehicle information analyzing unit 140 analyzes a position, a driving speed, a driving path history, and driving prediction path information of the rear vehicle.

The head lamp setting unit 150 may set a control length and a control width of a head lamp provided in the vehicle using analysis results of the road information analyzing unit 120, the front vehicle information analyzing unit 130, and the rear vehicle information analyzing unit 140.

Here, the head lamp setting unit 150 may set the control length and the control width of the head lamp according to the driving path history of the front vehicle and a lane width when the front vehicle is present. In addition, the head lamp setting unit 150 sets the control length and the control width of the head lamp according to the driving prediction path of the rear vehicle and the lane width when the rear vehicle is present. In addition, the head lamp setting unit 150 sets the control length and the control width of the head lamp according to the driving path history of the front vehicle, the driving prediction path of the rear vehicle, and the lane width when both of the front vehicle and the rear vehicle are present

Meanwhile, the head lamp setting unit 150 may set the control length and the control width of the head lamp according to a road curvature when other vehicles are not present in front of or behind of the corresponding vehicle. Here, the head lamp setting unit 150 sets each of the control lengths and the control widths of a left head lamp and a right head lamp. When head lamps are provided at upper and lower portions of the left and upper and lower portions of the right, respectively, the head lamp setting unit 150 may set each control length and control width of the head lamps provided at the upper and lower portions of the left and the upper and lower portions of the right, respectively.

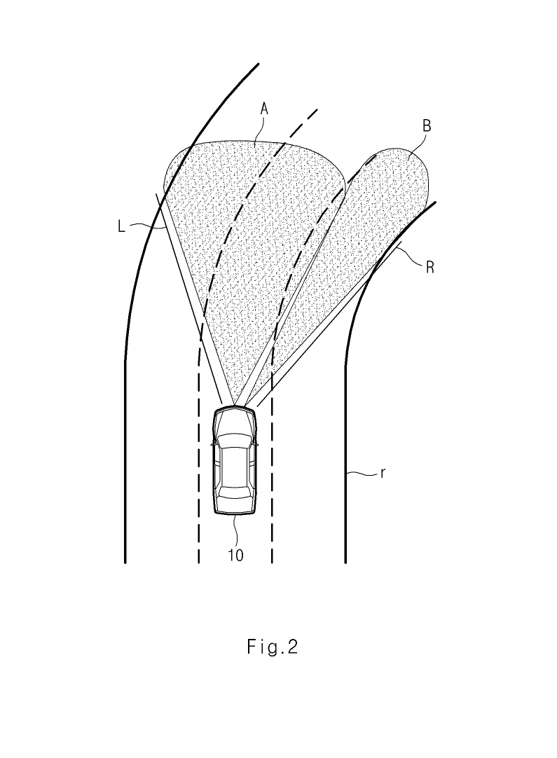

An operation of setting the control length and the control width of the head lamp in the head lamp setting unit 150 will be described in more detail with reference to FIGS. 2 to 6.

The head lamp driving unit 160 operates the head lamp based on the control length and the control width set based on at least one of the road information, the information related to the front vehicle, and the information on the rear vehicle. Here, the head lamp driving unit 160 controls the driving of the head lamp before the rear vehicle approaches a predetermined distance range behind the vehicle when the rear vehicle is present. In this case, it is possible to prevent a head lamp of a corresponding vehicle from obscuring a field of vision of a driver of the rear vehicle at a point in time when the rear vehicle moves ahead of the corresponding vehicle.

Here, when the head lamps are provided at the left and the right or the upper and lower portions of the left and the upper and lower portions of the right, respectively, the head lamp driving unit 160 drives each of the head lamps according to the control lengths and the control widths set for each of the head lamps.

FIGS. 2 to 6 are illustrative diagrams for describing an operation of the apparatus for controlling a head lamp of a vehicle according to the exemplary embodiment of the present invention.

First, FIG. 2 shows a head lamp control operation when the front vehicle and the rear vehicle are not present. Referring to FIG. 2, the apparatus for controlling a head lamp collects peripheral information of a vehicle 10 and controls a control length and a control width of the head lamp based on road information when a front vehicle and a rear vehicle are not present.

Particularly, the apparatus for controlling a head lamp sets a control length and a control width for a lighting area A of a left head lamp of the vehicle and sets a control length and a control width for a lighting area C of a right head lamp, based on a road width and a road curvature. Here, the respective set lighting areas do not deviate from a left reference line L and a right reference line R set based on the road width and the road curvature. Therefore, the apparatus for controlling a head lamp drives the left and right head lamps according to the control lengths and the control widths set as described above.

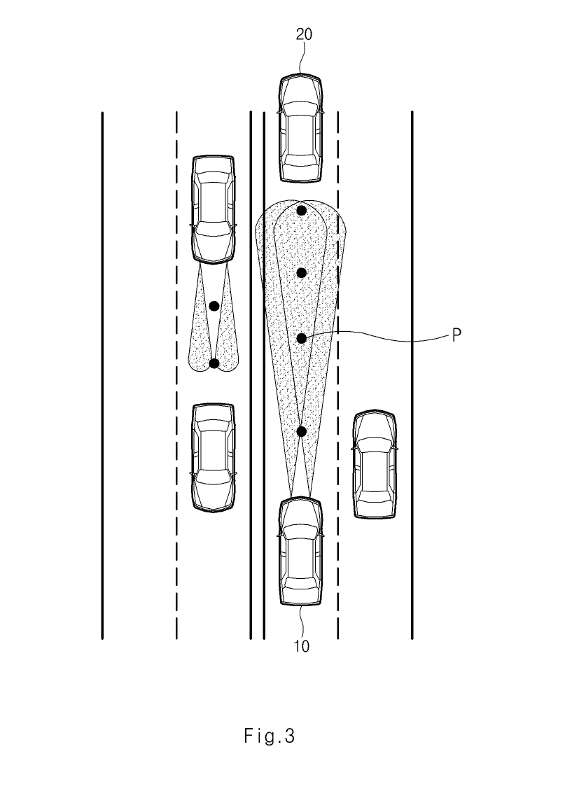

Meanwhile, FIG. 3 shows a head lamp control operation in which the front vehicle is present. Referring to FIG. 3, the apparatus for controlling a head lamp collects the peripheral information of the vehicle 10 and controls a control length and a control width of the head lamp using the road information and information on a front vehicle 20 when the front vehicle 20 is present.

Particularly, the apparatus for controlling a head lamp sets control lengths and control widths for left and right head lamps of the vehicle 10 based on a lane width and a driving path history P of the front vehicle 20. More specifically, the apparatus for controlling a head lamp receives information on the driving path history P of the front vehicle 20 including movement GPS coordinate information of the front vehicle 20 for communication with the front vehicle 20 and sets the control length of the head lamp based on a final position coordinate value of the front vehicle 20 from the received driving path history P. In addition, the apparatus for controlling a head lamp sets the control width of the head lamp based on the lane width of the front of the vehicle 10.

Therefore, the apparatus for controlling a head lamp allows the head lamp to project light to the rear side of the front vehicle in the lane width in which the vehicle 10 is being driven when the front vehicle 20 is present. In this case, the apparatus for controlling a head lamp may additionally control a vertical lighting angle of the head lamp according to a vehicle height of the front vehicle 20. Therefore, a driver of the front vehicle 20 may drive the vehicle without being blinded by the head lamp of the vehicle 10.

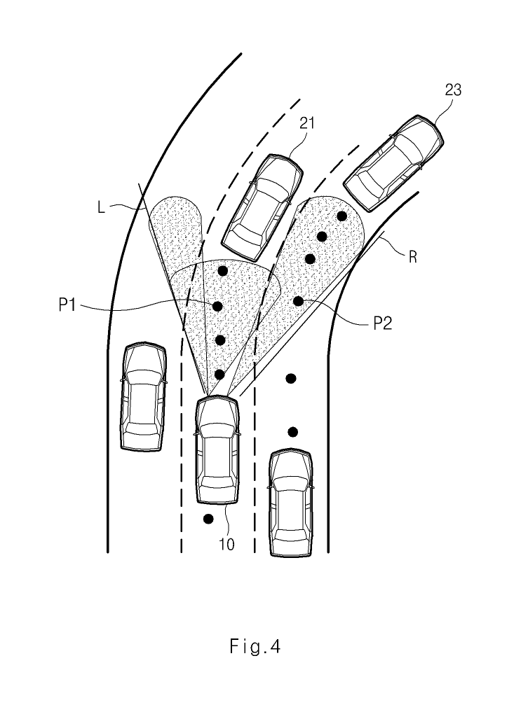

Meanwhile, FIG. 4 shows a head lamp control operation when the front vehicle and the rear vehicle are present. Referring to FIG. 4, the apparatus for controlling a head lamp collects the peripheral information of the vehicle 10 and controls a control length and a control width of the head lamp using the road information, information on the front vehicles 21 and 23, and information on the rear vehicle when the front vehicles 21 and 23 and the rear vehicle are present.

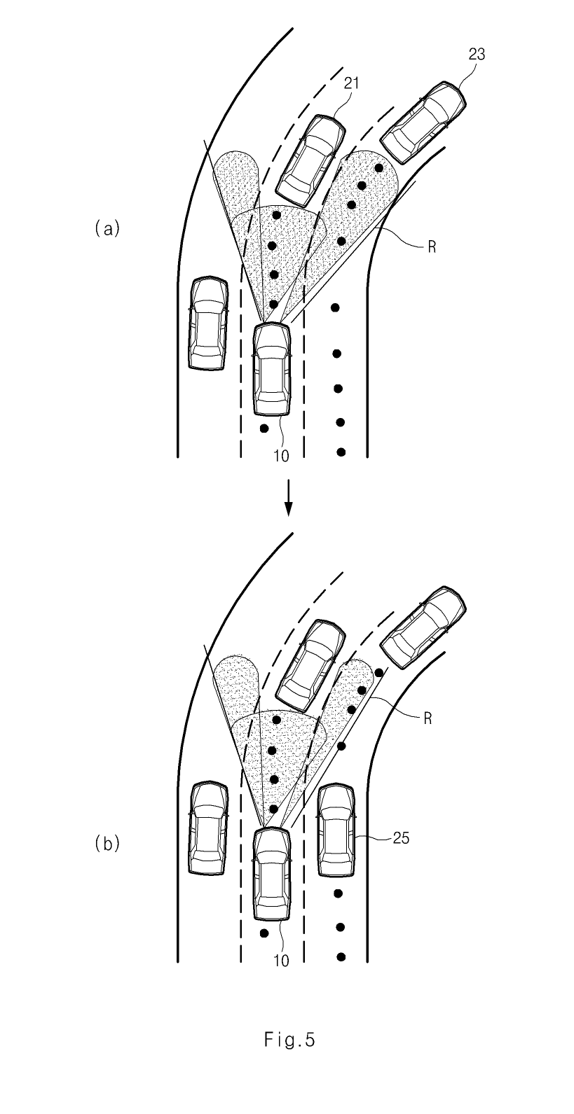

Here, the apparatus for controlling a head lamp controls the head lamp based on a lane width and a final position coordinate value of a driving path history P1 of the front vehicle, similar to FIG. 3, before the rear vehicle approaches a predetermined distance range of the rear of a corresponding vehicle as shown in FIG. 5A.

The apparatus for controlling a head lamp receives information on a driving prediction path P2 of the rear vehicle through communication with the rear vehicle and calculates a control length and a control width of the head lamp in advance based on the received driving prediction path P2. Then, when the rear vehicle approaches the predetermined distance range of the rear of the corresponding vehicle, the apparatus for controlling a head lamp drives the head lamp according to the calculated control length and control width before the rear vehicle moves ahead of the corresponding vehicle.

Therefore, the driver of the rear vehicle 25 may drive the rear vehicle without being blinded by the head lamp of the vehicle 10 even when the rear vehicle moves ahead of the vehicle 10 as shown in FIG. 5B.

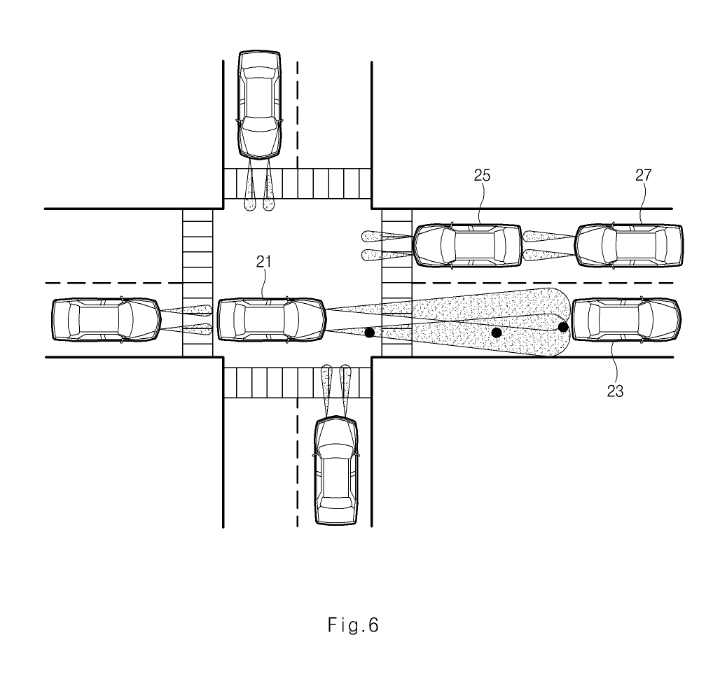

FIG. 6 shows a head lamp control operation when a vehicle enters an intersection. Referring to FIG. 6, the apparatus for controlling a head lamp of a vehicle 21 passing through the crossroad controls the head lamp based on a lane width and a final position coordinate value of a driving path history of a front vehicle 23, similar to FIG. 4. Meanwhile, the apparatus for controlling a head lamp of a vehicle 25 that is waiting for an intersection signal in a state in which a stop line is positioned in front of the vehicle 25 controls the head lamp based on a lane width and a position of the stop line. In addition, the apparatus for controlling a head lamp of a vehicle 25 that is waiting for an intersection signal in a state in which another vehicle is positioned in front of the vehicle 27 controls the head lamp based on a lane width and a position of the front vehicle 25.

An operation flow of the apparatus for controlling a head lamp of a vehicle according to the exemplary embodiment of the present invention configured as described above will be described below in detail.

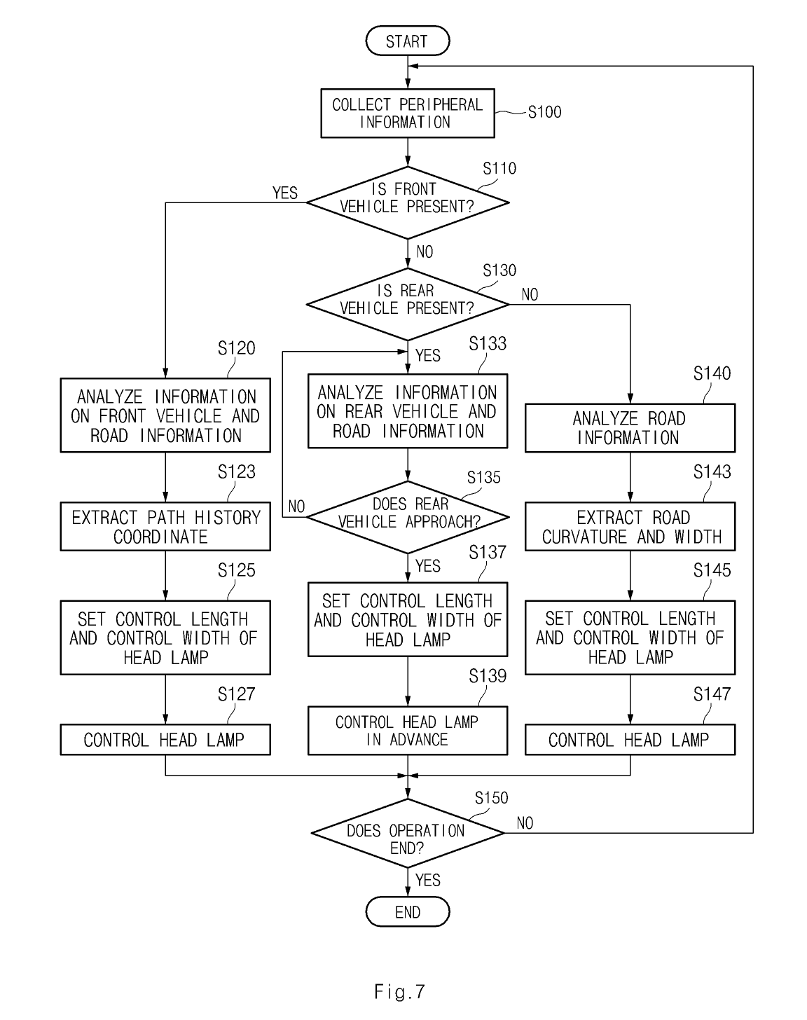

FIG. 7 is a flow chart showing an operation flow of a method for controlling a head lamp of a vehicle according to the exemplary embodiment of the present invention.

Referring to FIG. 7, the apparatus for controlling a head lamp of a vehicle according to the exemplary embodiment of the present invention collects the peripheral information of the vehicle (S100). In the process ‘S100’, the peripheral information may be collected by a sensor provided within or on the vehicle or by communication between peripheral vehicles. Here, the peripheral information includes road information such as a lane, a lane width, a road width, a road curvature, and the like, and vehicle information on a front vehicle or a rear vehicle.

When the front vehicle is present in front of the vehicle (S110) based on the peripheral information collected in the process ‘S100’, the apparatus for controlling a head lamp of a vehicle according to the exemplary embodiment of the present invention analyzes the information on the front vehicle and the road information (S120) and extracts coordinate information according to a driving path history of the front vehicle (S123). Then, the apparatus for controlling a head lamp of a vehicle according to the exemplary embodiment of the present invention sets the control length and the control width of the head lamp (S125) based on the coordinate information extracted in the process ‘S123’ and controls the head lamp according to the set control length and control width (S127).

Although not shown in FIG. 7, the apparatus for controlling a head lamp of a vehicle may continuously confirm whether or not the rear vehicle is present even after a process ‘S127’ and additionally perform processes of ‘S133’ to ‘S139’ when the rear vehicle is present.

Meanwhile, when the front vehicle is not present and only the rear vehicle is present (S130) in the process S100’, the apparatus for controlling a head lamp of a vehicle analyzes the information relating to the rear vehicle and the road information (S133) to extract the driving prediction path of the rear vehicle. In this case, the apparatus for controlling a head lamp of a vehicle sets the control length and the control width of the head lamp based on the driving prediction path information of the rear vehicle (S137) when the rear vehicle approaches or enters a predetermined distance range from the rear of a corresponding vehicle (S135), and controls the head lamp according to the control length and the control width set in the process ‘S137’ (S139).

Meanwhile, when both of the front vehicle and the rear vehicle are not present in the processes ‘S110’ and ‘S130’, the apparatus for controlling a head lamp of a vehicle analyzes the road information (5140) and extracts the information on the road curvature and width (S143). Then, the apparatus for controlling a head lamp of a vehicle according to the exemplary embodiment of the present invention sets the control length and the control width of the head lamp (S145) based on the road curvature and width extracted in the process ‘S143’ and controls the head lamp according to the set control length and control width (S147).

Although not shown in FIG. 7, the apparatus for controlling a head lamp of a vehicle may continuously confirm whether or not the rear vehicle is present even after a process ‘S147’ and additionally perform processes of ‘S133’ to ‘S139’ when the rear vehicle is present

According to the exemplary embodiments of the present invention, the head lamp of the vehicle is controlled in advance based on the driving prediction path of the rear vehicle, thereby making it possible to prevent the head lamp of a corresponding vehicle from obscuring the driving of the rear vehicle even when the rear vehicle moves in front of the corresponding vehicle.

In addition, according to the exemplary embodiments of the present invention, the lighting area of the head lamp of the vehicle is adjusted according to the positions of the front vehicle and the rear vehicle and the road situation, thereby making it possible to prevent a field of vision of a driver of the peripheral vehicle from being obscured while insuring a proper field of vision of the driver of the vehicle.

Although the apparatus and the method for controlling a head lamp of a vehicle according to the exemplary embodiment of the present invention have been described with reference to the accompanying drawings, the present invention is not limited to the exemplary embodiment and the accompanying drawings disclosed in the present specification, but may be modified without departing from the scope and spirit of the present invention.

What is claimed is:

1. An apparatus for controlling a head lamp of a vehicle, the apparatus comprising:
a controller including:
a road information analyzing unit configured to analyze information related to a road on which a vehicle is being driven from information collected in the vicinity of the vehicle through a sensor to recognize a road state;
a rear vehicle information analyzing unit configured to analyze information on a rear vehicle positioned behind the vehicle from the information collected in the vicinity of the vehicle or information obtained through communication between vehicles to recognize a driving situation of the rear vehicle;
a head lamp setting unit configured to set a control length and a control width of the head lamp based on the road state and the driving situation of the rear vehicle; and
a head lamp driving unit configured to operate the head lamp based on the set control length and control width of the head lamp.

2. The apparatus according to claim 1, wherein the head lamp setting unit sets the control length and the control width of the head lamp according to a driving prediction path and a speed of the rear vehicle.

3. The apparatus according to claim 1, wherein the head lamp driving unit controls driving of the head lamp when the rear vehicle approaches a predetermined distance range of the rear of the vehicle.

4. The apparatus according to claim 1, further comprising a front vehicle information analyzing unit analyzing information relating to a front vehicle positioned in front of the vehicle based on the information collected in the vicinity of the vehicle or information obtained through communication between vehicles to identify a driving situation associated with the front vehicle.

5. The apparatus according to claim 4, wherein the head lamp setting unit sets the control length and the control width of the head lamp by reflecting the driving situation of the front vehicle in the road state and the driving situation of the rear vehicle.

6. The apparatus according to claim 5, wherein the head lamp driving unit controls driving of the head lamp based on at least one of the road state and the driving situation of the front vehicle before the rear vehicle approaches a predetermined distance range from the rear of the vehicle.

7. The apparatus according to claim 4, wherein the head lamp setting unit sets the control length and the control width of the head lamp based on the road state and a final position coordinate value of a driving path history of the front vehicle when the rear vehicle is not present.

8. The apparatus according to claim 4, wherein the head lamp setting unit sets the control length and the control width of the head lamp based on information on a road curvature when the rear vehicle and the front vehicle are not present

9. The apparatus according to claim 4, wherein the head lamp setting unit sets the control length and the control width of the head lamp based on a final position coordinate value of a driving path history of the front vehicle or a position of a stop line of the front when the vehicle is in a state in which it waits for a signal at an intersection.

10. A method for controlling one or more head lamps of a vehicle, the method comprising:
analyzing, by a controller, information on a road on which a vehicle is being driven from information collected in the vicinity of the vehicle through a sensor to recognize a road state;
analyzing, by the controller, information relating a rear vehicle positioned behind the vehicle via the information collected in the vicinity of the vehicle or information obtained through communication between vehicles to recognize a driving situation of the rear vehicle;
setting, by the controller, a control length and a control width of the head lamp based on the road state and the driving situation of the rear vehicle; and
operating, by the controller, the one or more head lamps based on the set control length and control width of the head lamp.

11. The method according to claim 10, wherein in the setting, the control length and the control width of the head lamp are set according to a driving prediction path and a speed of the rear vehicle.

12. The method according to claim 10, wherein in the driving, driving of the head lamp is controlled when the rear vehicle approaches or enters a predetermined distance range of the rear of the vehicle.

13. The method according to claim 10, further comprising analyzing information on a front vehicle positioned in front of the vehicle from the information collected in the vicinity of the vehicle or information obtained through communication between vehicles to recognize a driving situation of the front vehicle,
wherein in the setting, the control length and the control width of the head lamp are set based on the road state or a final position coordinate value of a driving path history of the front vehicle when the rear vehicle is not present or before the rear vehicle approaches a predetermined distance range of the rear of the vehicle.

14. The method according to claim 13, wherein in the setting, the control length and the control width of the head lamp are set based on information on a road curvature when the rear vehicle and the front vehicle are not present.

15. The method according to claim 13, wherein in the setting, the control length and the control width of the head lamp are set based on a final position coordinate value of a driving path history of the front vehicle or a position of a stop line of the front when the vehicle is in a state in which it waits for a signal at an intersection.
